(19) United States
(12) Patent Application Publication
(10) Pub. No.: US 2025/0192143 A1
(43) Pub. Date: Jun. 12, 2025

(54) PRE-LOADED PROTECTED ANODE, BATTERY AND MANUFACTURING METHOD

(71) Applicant: LionVolt B.V., Veldhoven (NL)

(72) Inventors: SANDEEP UNNIKRISHNAN, Eindhoven (NL); FREDDY ROOZEBOOM, Eindhoven (NL); SATHIYARAJ KANDHASAMY, Eindhoven (NL); BIHAG ANOTHUMAKKOOL, Eindhoven (NL)

(21) Appl. No.: 18/841,250

(22) PCT Filed: Feb. 24, 2023
(86) PCT No.: PCT/NL2023/050092

§ 371 Date: Aug. 23, 2024

(30) Foreign Application Priority Data
Feb. 24, 2022 (NL) 2031071

(51) Int. Cl. H01M 4/1395; H01M 4/04; H01M 4/134; H01M 4/38; H01M 4/78

(52) U.S. Cl. CPC H01M 4/1395; H01M 4/0404; H01M 4/0452; H01M 4/134; H01M 4/382; H01M 4/78

(57) ABSTRACT

The present disclosure relates to a method of manufacturing an electrode (In) comprising a current collector element (10) and a coating of a solid or semi-solid electrolyte (20) and the corresponding electrode part. The method comprises depositing (300) an amount of an anode metal composition as a layer between the current collector element and the solid state electrolyte covering the current collector element by an electroplating process that involves a directed transfer of anode metal ions through the electrolyte coat, wherein the solid state electrolyte comprises i) a first layer covering the current collector element that, at least initially contains, one or more additives forming a solid electrolyte interphase layer by reaction with the plated anode metal composition, and ii) a second layer covering the first layer that is resistive to inward permeation of solvent comprised in the plating electrolyte (302). The disclosure further relates to a battery comprising the electrode part.

### TECHNICAL FIELD AND BACKGROUND

The present disclosure relates to electrode parts. In particular comprising a current collector element and a coating of a solid-state electrolyte and such electrode parts that preloaded with an amount of an anode metal composition. The present disclosure relates to a battery, such as a lithium based battery, comprising the electrode part with preloaded anode metal composition and methods of manufacturing the electrode part and battery.

Rechargeable lithium-ion batteries (LiBs) are today's technology of choice in electromobility and renewable energy storage grids. To improve energy density, next-generation battery technologies tend to move towards lithium metal anodes, with a potentially high specific capacity of 3860 mAh/g and a low redox potential of −3.04 V. These anodes may be combined a cathode from various chemistry choices such as NMC (lithium nickel manganese cobalt oxide), LFP (lithium iron phosphate), LNMO (lithium nickel manganese oxide), sulfur, or air.

During charging Li-ions travel from the cathode through an electrolyte to the anode to be deposited as Li metal (Li⁰). During discharge they travel back to cathode. However, during plating/de-plating cycles the battery incurs losses of lithium due to adverse reactions of lithium with electrolyte and/or due to generation of porous or dendritic lithium deposits, which further present a progressively increasing danger in shorting, reducing operable battery lifetime and performance.

X. Zhang et al. (Acc. Chem. Res., 52, 3223-3232, 2019) describe dendrite suppression strategies that can reduce the loss of Li during the battery operation. However, Li losses, in particular during a first plating cycle remain disproportionally high.

Compensating for lost lithium is not evident due to the high reactivity of lithium (as other alkali metals) towards ambient, which result in the formation of disadvantageous resistive oxidic and/or nitridic surface layers that have a negative influence on battery cycling, and that can negatively impart lithium deposition thereon and thus battery life. To mitigate growth of oxidic surface layers, lithium can be processed in Ar atmosphere. However, in practice, this does not satisfactory reduce growth rates and further adds significantly on the operational costs.

WO2018190559A1 discloses electroplating of Li onto a current collector from a plating solution comprising lithium nitrate and a metal nitrate.

CN112670450A discloses electroplated lithium followed by a N₂ gas exposure and coverage with polymer/solid electrolytes in an attempt to reduce surface oxidation.

However, there remains a need to solutions that provide a way to provide lithium metal while mitigating generation of oxidic surface layers.

### SUMMARY

The present disclosure aims to overcome known limitations by simultaneously providing electrode parts that comprise a pre-loaded amount of anode metal, e.g. lithium, that is covered by an electrolyte, typically a solid-state electrolyte layer, which shields the lithium from ambient.

The present disclosure provides an effective, production-compatible, surface protection of reactive anode metals, e.g. Li.

Simultaneously the presently disclosed solution improves subsequent anode metal plating, mitigating porous/dendritic anode metal deposition, improving battery lifetime and mitigating short circuit risks.

In particular, aspects of the present disclosure relate to a method of manufacturing an electrode part comprising a current collector element and a solid or semi-solid layer, coat, an electrolyte that is provided along a face of the current collector element.

The method as disclosed herein advantageously provides an electrode part having a pre-loaded amount of an anode metal composition. Among others the method mitigates degradation of loaded anode metal, e.g. lithium metal, due to contact with ambient. The electrode part can be used to advantage as negative electrode part in a battery application, e.g. a rechargeable lithium metal battery, whereby the electrolyte layer, due to its solid or semi-solid nature, can advantageously be used as an ion conductive separator between the electrode part and a counter electrode. As will be detailed hereinbelow the disclosure further provides one or more improved battery performance in terms of energy density, safety and/or lifetime.

The method of manufacturing the electrode part comprises plating an amount of an anode metal composition, typically comprising one or more alkali metal, such as lithium, sodium or potassium, as a layer between the current collector element and the electrolyte covering the current collector element by an electroplating process. The electroplating process involves a directed transfer of anode metal ions through the electrolyte coating from an anode metal source, e.g. a plating electrolyte, towards the current collector element, wherein the solid or at least semi solid electrolyte layer comprises one or more additives, at least prior to plating, that forms a solid electrolyte interphase (SEI). The SEI is formed as a layer along an interface between the current collector element and the electrolyte by a reaction with plated anode metal. The SEI layer allows transport of anode metal ions towards the current collector element for further plating while protecting the formed anode metal, which is typically highly reactive, by hindering permeation of reactive species, such as O₂, N₂ and/or CO₂ from ambient (e.g. in a production environment such as a dry room). Protecting the underlying anode metal composition, form degradation advantageously mitigates degradation of anode metal and formation of materials (e.g. oxides and/or nitrides). Mitigating degradation of anode metal can advantageously improve a content of accessible battery active materials within a battery context, e.g. improving energy density. Mitigating degradation of anode metal can further improve electrode and/or battery performance and/or safety, e.g. in terms of improving plating homogeneity during electrode operation or battery cycling.

The solid or semi-solid electrolyte is advantageously also resistive to inward permeation of solvent comprised in the plating electrolyte. Avoiding or at least mitigating inward permeation of solvent comprised in the plating electrolyte mitigates degradation/reaction of plated anode metal with the solvent.

The electrolyte layer is typically formed as a stack with at least two distinct layers, including a first layer that covers, typically directly contacts, the current collector element and that, at least initially, contains the one or more functional additives forming an SEI layer. After plating, e.g. in the finished electrode part, the amount of additives is obviously reduced, optionally down to zero or essentially zero. Covering the first layer is a second layer that is resistive to inward permeation of solvent comprised in the plating electrolyte. Providing separate layers advantageously separates SEI-formation from resisting inward permeation of solvent comprised the plating electrolyte.

In a preferred embodiment, the current collector element is formed as a flexible foil, e.g. a metal foil or a metal-coated flexible carrier. Accordingly, the formed electrode part can advantageously be flexible. The method of manufacturing can advantageously be configured as a roll-to-roll process. Accordingly, in a preferred embodiment, the method comprises conveying the foil past a station configured for applying the electroplating process. Roll-to-roll manufacturing can advantageously enable manufacturing the electrode part in bulk using a cost-effective continuous process yielding a roll of a pre-loaded electrode.

In another or further preferred embodiment, the method comprises controlling, e.g. by a controller, the amount of the electroplated anode metal in accordance with a pre-defined target (e.g. anode metal layer thickness) by one or more of controlling one or more plating parameters including a magnitude, a duration and/or a pulse shape of an electroplating current during the electroplating and/or by controlling a contact time of the substrate with the plating electrolyte (e.g. residence time in a plating bath).

The disclosure further relates to an electrode part comprising a current collector element and an electrolyte layer that is provided along a face of the current collector element. It will be understood that part can be manufactured by the method according to the disclosure.

The electrode part, e.g. as manufactured by the disclosed process, advantageously comprises a pre-loaded amount of an anode metal composition. The anode metal composition is provided as a layer between the current collector element and the electrolyte coat. A solid electrolyte interphase formed as a layer along an interface between the electrolyte and the layer of the anode metal composition mitigates anode metal degradation by reaction of anode metal with ambient. The current collector element and formed electrode part can advantageously be flexible. Because the anode metal is protected the electrode part can advantageously, be stored as a roll, sheets or as pieces cut to size for further use, e.g. in a battery.

In some embodiments, there is provided an electrode part, preferably obtainable by the method as disclosed herein, comprising a current collector element with an electrolyte coating provided thereon, the electrolyte coating containing i) a first layer covering the current collector element that optionally contains one or more functional additives forming a solid electrolyte interphase layer by reaction upon reaction with a plated anode metal composition provided by the electroplating, and ii) a second layer covering the first layer, a pre-loaded amount of an anode metal composition provided as a layer between the current collector element and the electrolyte coating, and a solid electrolyte interphase formed as a layer along an interface between the coat of the electrolyte and the layer of the anode metal composition, whereby the second layer is comparatively more resistant to plating solvent, e.g. to ingress of solvent ingress from a plating solution, than the first layer.

Without wishing to be bound by theory inventors find that more resistant to plating solvent (e.g. ingress of plating solvent) can be understood as being comprised of a composition that is comparatively more apolar than the first layer. Alternatively, or in addition, more resistant to solvent ingress can be understood as having a comparatively lower affinity (mutual solubility) to plating solvents. Plating solvents can be understood as solvents selected from a group including but not limited to: DOL (Dioxolane), DME (Dimethoxyethane), EC (Ethylene carbonate), and DEC (Diethyl carbonate), DMC (dimethylcarbonate), FEC (Fluoroethylene carbonate), VC (Vinylene carbonate), PC (Propylene carbonate), HFE (Hydrofluoroethers), FEMC (trifluoroethyl methyl carbonate).

The present disclosure further relates to an electrode part for use in the electroplating process according to any of claims 1-9, the part comprising: a current collector element, and an electrolyte coating provided thereon, wherein the electrode part comprises no pre-deposited amount of anode metal, and wherein the electrolyte coating contains i) a first layer covering the current collector element that contains one or more functional additives forming a solid electrolyte interphase layer upon reaction with a plated anode metal composition provided by the electroplating, and ii) a second layer covering the first layer that is comparatively more resistant to solvent ingress from a plating solution than the first layer. Because said part does not yet include an amount of highly reactive anode metal said part can be stored, as production part, under mild conditions for later usage (e.g. subsequent plating and/or battery assembly).

It will be appreciated that the electrode part can advantageously be configured as a dual sided electrode part wherein respective ones of the electrolyte coating are provided on opposing sides of a current collector element.

The present disclosure further relates to a battery, comprising the electrode part pre-loaded with a layer of an anode metal composition. The pre-loaded electrode part is typically used as a so-called negative electrode of an anode metal battery, preferably a rechargeable anode metal battery such as a secondary lithium metal battery (LMB). LBMs advantageously offer a higher energy density as compared to secondary batteries used a composite anode composition such as LiC or LiSi as electro-active composition.

The battery typically comprises a counter electrode part (as a positive electrode) that is positioned across the electrode part. In a preferred embodiment, the battery includes a cathode composition that is provided along a face of the counter electrode part along a face facing the pre-loaded electrode part. Advantageously the solid or semi-solid electrolyte can act as a separator element that separates the anode from the cathode composition. Optionally, the electrolyte may be provided, e.g. impregnated with a liquid electrolyte. Alternatively, or in addition, the battery may include an additional separator, e.g. a porous structure carrying an electrolyte, to improve ion transport between the negative and positive electrode parts.

In a preferred embodiment, the battery is formed as a secondary lithium metal ion battery, wherein the cathode composition and the pre-loaded layer of the anode metal composition comprise lithium. The pre-loaded lithium metal layer advantageously provides a buffer amount of lithium additional to a lithium inventory provided by the cathode composition. The pre-loaded lithium metal layer advantageously acts both as nucleation layer for subsequent anode metal plating (e.g. during an initial and subsequent, charging, operations of the battery, and as buffer to replace losses from the lithium inventory during at least the initial ones of lithium metal plating and de-plating processes during battery operation. As compared to batteries without pre-loaded metal layer (e.g. LMBs that require an initial internal plating process) the pre-loaded anode metal layer advantageously increases lifetime of the battery (replacing losses) while simultaneously improving battery safety by acting as a nucleation layer that improves the homogeneity of subsequently plated metal layers.

In another embodiment the electrode part is employed as negative in a secondary lithium-sulfur battery (LiS) or in a secondary lithium-air battery (Li-air). In these embodiments the layer of the anode metal composition can provide the lithium inventory of the battery.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A provides a schematic exploded side-view of a battery comprising an electrode part as disclosed herein;

FIG. 1B provides a schematic side view of an electrode part as disclosed herein;

FIG. 2A; schematically illustrates a method of manufacturing an electrode part as disclosed herein;

FIG. 2B illustrates aspects of manufacturing an electrode part as disclosed herein;

FIGS. 2C and 2D provide side views of current collector elements;

FIG. 3A illustrates aspects of manufacturing an electrode part as disclosed herein;

FIG. 3B illustrates aspects relating to a roller;

FIG. 3C schematically illustrates a method of manufacturing a battery;

FIG. 4A provides a detail view of aspects relating to manufacturing an electrode part;

FIG. 4B schematically illustrates an embodiment of a battery during a use condition;

FIG. 4C schematically illustrates a further embodiment of a battery during a use condition;

FIG. 5A illustrates further aspects of manufacturing an electrode part as disclosed herein; and

FIGS. 5B, 5C and 5D illustrate exemplary electrode parts prior to preloading an anode metal composition.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise, it will be understood that when a connection between structures or components is described, this connection may be established directly or through intermediate structures or components unless specified otherwise.

As used herein the term positive electrode or cathode and the terms negative electrode or anode refer to terminology commonly used to identify electrodes of a battery during a discharge operation. In discharging battery mode, the anode is the “negative electrode” to which the positive current flows, from the cathode, being the “positive electrode”. During charge these functions are reversed. Irrespective of charging mode, the electrochemical relationship may be characterized by charge exchange between a negative electrode material (anode composition) and a positive electrode material (cathode composition), the negative electrode material having a work function or redox potential that is lower than the work function or redox potential of the positive electrode material.

The term solid state electrolyte is not to be construed as limited to defined as being composed entirely of solid state constituents. As expressed herein it is envisioned, even preferred that, the electrolyte includes non-solid ingredients such as liquids or waxy materials such as ionic liquids, succinonitrile, and/or organic solvent. As such the term solid state electrolyte expressly includes semi-solid compositions such as gels or solid composition impregnated with liquids and/or waxes.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

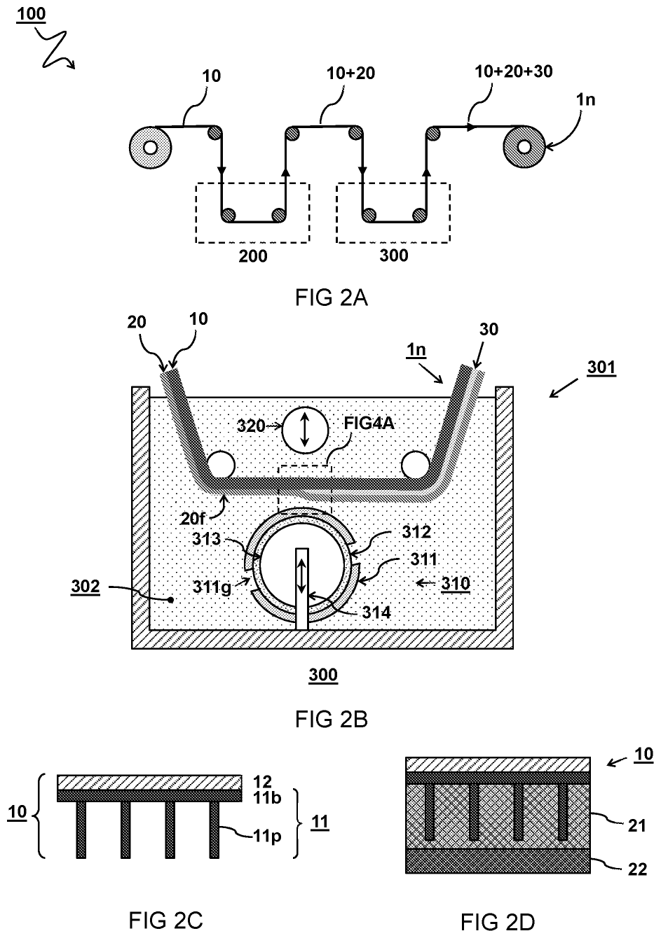

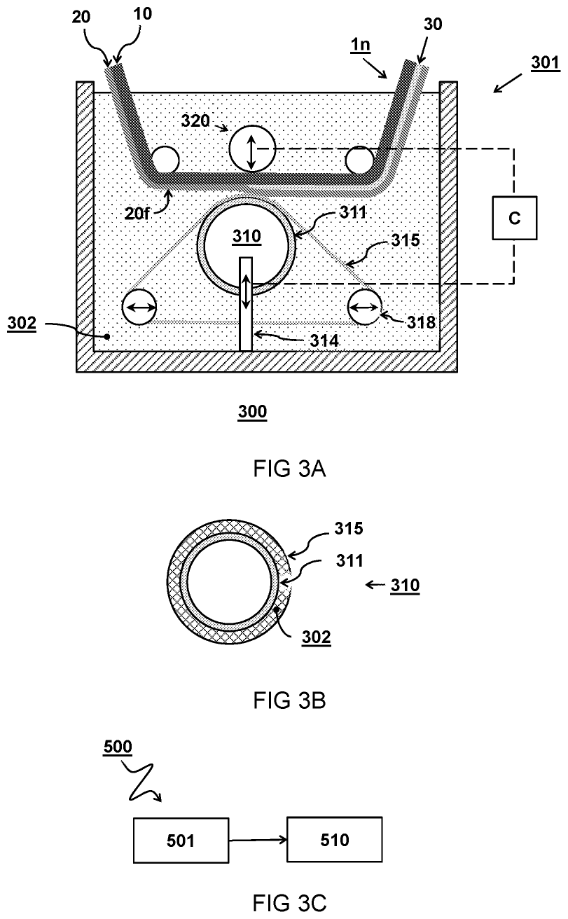

Aspects of the present invention related to a method of manufacturing an electrode part that comprises a current collector element and a coating of a solid or semi-solid electrolyte. In general terms, e.g. as shown in FIGS. 2A, 2B and 3A, method comprises at least a step of plating 300 an amount of an anode metal composition 30 as a layer between the current collector element 10 and the electrolyte 20 covering the current collector element 10. The anode metal composition is deposited between the electrolyte 20 layer and the current collector element 10 by an electroplating process that involves a directed transfer of corresponding ions, anode metal ions, through electrolyte layer from a plating electrolyte 302 to the current collector element 10. Most relevant aspects as to anode metal plating process will be explained in more detail with reference to FIG. 2B.

The anode metal composition typically comprises, or essentially consists of, one or more alkali metals selected from the group lithium (Li), sodium (Na) and potassium (K). Lithium being preferred in terms of its comparatively advantageous redox potential and attainable power density. It is to be noted that the plating process differs from in-situ anode metal plating processes (e.g. during an initial charging cycle) within anode metal batteries in that the present process resulting in formation of an electrode part (in isolation) having a pre-loaded amount of lithium metal, whereby the lithium is obtained from an external source, as opposed to within a closed context of a battery whereby plated lithium metal is drawn from an overall lithium inventory within the battery. Importantly formed electrode parts as obtained by the present electroplating method differ from parts manufactured in a process involving a deposition of anode method (e.g. lithium metal evaporation) prior to deposition of the solid or semi-solid electrolyte 20. As will be explained in more detail hereinbelow electrode parts 1n formed according to the present disclosure most notably differ in that the deposited layer of anode metal is intrinsically covered by a previously deposited layer of electrolyte 20. This layer advantageously covers the underlying anode metal already from its deposition and during subsequent processing or storage stages, thereby mitigating degradation of deposited anode metal (e.g. lithium) due to reaction with reactive species from ambient (such as O₂, N₂ and CO₂), which are known to react with virgin alkali metals (e.g. Li-metal, Li⁰), as commonly present in manufacturing dry-rooms and even as unavoidable traces in case processing is performed under inert atmosphere (e.g. Argon), which would disadvantageously render production highly complex and expensive, all the more for industrial-scale production.

The composite electrolyte is configured to allow transport of anode metal ions while being sufficiently rigid, solid, to separate the negative electrode part from a corresponding positive electrode (cathode). In some embodiments, the electrode part 1n can be incorporated in a battery structure whereby the electrolyte 20 acts as a separator that electrically separates the anode from an opposing electrode 1p while allowing ion transport therebetween. The opposing electrode 1p comprises an electron conductive current collector 80 for providing/collecting of electrons. The cathode current collector 80 may, e.g. as shown, be provided as an electron conductive film 81 on a carrier 82, preferably a flexible carrier.

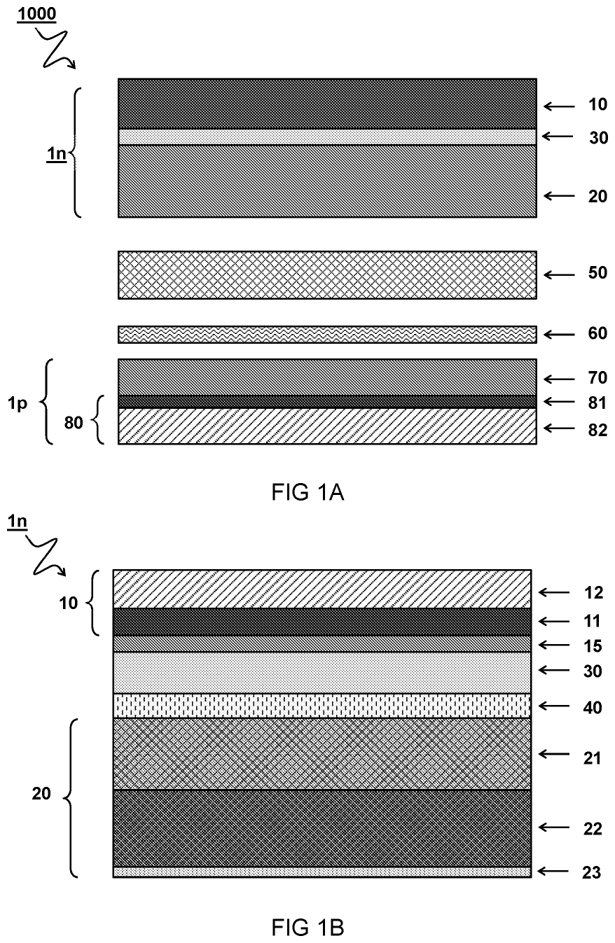

In some embodiments, e.g. as shown in FIG. 1A, the negative electrode part may be incorporated in a battery structure 1000 that comprises one or more separator structures 50 between the electrode part 1n and the counter electrode part 1p. Alternatively, or in addition, the battery may include one or more electrolyte compositions, such as a catholyte 60, to improve ion transport between cathode and anode.

In any case the electrolyte 20 comprises, at least prior to plating, one or more functional additives that react with plated anode metal to form a layer of what is known in the field as a solid electrolyte interphase (SEI). Upon plating the additives partake in a reaction with the anode metal forming the SEI. After plating the amount of additives is obviously reduced and can even be essentially zero.

To avoid reaction of virgin plated anode metal with solvents as comprised in the plating electrolyte 302 the electrolyte 20 layer is generally also resistive to inward permeation of said solvent(s). The solid or semi-solid electrolyte 20 is generally a hybrid or composite electrolyte that comprises a polymer matrix, a metal salt dispersed in the hybrid solid electrolyte, typically throughout the polymer matrix and preferably one or additives to improve anode metal ion conductance.

The polymer matrix can be formed of any suitable composition. Typically the matrix comprises one or more polymers as known in the field, including but not limited to polyacrylates, polyethers, polyesters, polycarbonates, polyolefins, or copolymers thereof.

Accordingly, in some embodiments the method comprises a step of coating 200 the current collector 10 with a layer of the composite solid-state electrolyte 20, prior to the electroplating.

In a strongly preferred embodiment, e.g. as shown in FIG. 1B, the electrolyte 20 is formed as a stack comprising at least two distinct layers including i) a first layer 21 covering the current collector element 10 that, at least initially contains, the one or more functional additives forming a solid electrolyte interphase (SEI) 40 layer by reaction with the plated anode metal composition 30, and ii) a second layer 22 that covers the first layer 30 and that is resistive to inward permeation of solvent comprised in the plating electrolyte towards to first layer and/or the plated anode metal composition 30. Providing separate layers advantageously separates SEI-formation from resisting inward permeation of solvent comprised the plating electrolyte. That is to say, the composition of the first layer, comprising the SEI-forming additives can be tuned independent of the composition of the second layer being resistive, or at least less permeable, to inwards permeation of solvent comprised in the plating electrolyte 302. Accordingly, the multi-layer composite solid electrolyte will contain a first layer, an SEI forming layer 21, and second layer 22 that is resistive, e.g. essentially impermeable or at least more resistive than the first layer, to the liquid electrolyte used for electroplating. Solvent resistivity, or at least poor permeability, can be conveniently attained by selecting the matrix polymer and solvent comprised in the plating electrolyte 302. For example, the matrix polymer can be selected, depending on the solvents to be used in the plating electrolyte 302, to be mutually incompatible. For example, the matrix polymer comprised in the electrolyte 20, in particular in second layer 22, can be selected to be poorly soluble or even essentially insoluble in the solvents, or at least less soluble, preferably by at least 50%, than the polymer comprised in the first layer 21 (comprising the SEI-forming additives). Preferably, the matrix polymer comprised in the second layer has a solubility≤5 wt % in the solvents comprised in the plating electrolyte 302, more preferably ≤5 g/kg, even more preferably ≤1 g/kg under plating conditions.

To maintain ion conductance throughout the electrolyte both layers will generally contain corresponding anode metal salts. For lithium metal electrodes these additives include Li salts, such as LiTFSI (lithium bis(trifluoromethanesulfonyl)imide), LiCIO₄ (lithiumperchlorate), LiFSI (lithium bis(fluorosulfonyl)imide), LiBF₄ (lithium tetrafluoroborate), LiBOB a(Lithium Bis(oxalate)Borate), LiDFOB (Lithium difluoro (oxalate) borate), LiTf (Lithium trifluoromethanesulfonate), and/or LiTDI (lithium 2-trifluoromethyl-4,5-dicyanoimidazole).

In some embodiments, e.g. as shown in FIG. 1B, the electrode part comprises a further ion diffusive layer 23. The ion diffusive layer 23 is provided onto the electrolyte 20 coating along an external face opposite current collector element 10. The ion diffusive layer 23 is provided to electrolyte 20 prior to electroplating. The further ion conductive layer 23 comprises a composition and thickness to enable metal ion transport while at least contributing to mitigating ingress of solvent comprised in the plating electrolyte 302 towards the electrolyte 20 and accordingly to the anode metal composition 30, when plated. The layer typically comprises, or is essentially formed of, an inorganic or ceramic composition. Suitable compositions include aluminum oxide, titanium oxide, zinc oxide, and LiPON. Additionally (within a battery context) the ion diffusive layer 23 can shield the anode metal layer from solvents comprised in liquid battery electrolyte compositions, e.g. anolyte, if provided. The thickness of the ion diffusive layer 23 is generally sufficiently thin to allow metal ion passage. Thickness is in a range of about 1 to 10 nm, preferably between 1-5 nm, e.g. about 1-2 nm. Progressively thicker layers were found to increasingly hinder ion conductance while offering little additional benefit as to mitigating solvent ingress. The ion diffusive layer 23 can be conveniently provided at a suitable thickness using known methods including but not limited to dry vapor deposition methods such as PVD, CVD and ALD. Each of which can each de advantageously combined with a roll-to-roll process as disclosed herein.

SEI-forming additives known to form a stable SEI layer are generally known in the field. Additives include but are not limited to: succinonitrile; ionic liquids, e.g. N-Propyl-N-methylpyrrolidinium; lithium salts such as lithium bis(trifluoromethanesulfonyl)imide, lithium bis(fluorosulfonyl)imide, lithium tetrafluoroborate, lithium dioxalate borate, lithium fluoride, lithium hexafluoroarsenate, lithium hexafluorophosphate, lithium nitrate; or a combination thereof. Advantageously the matrix polymer can be a polymer found to favorably contribute to SEI-formation, including, but not limited to: polyethers, such as PEO or a co-polymer; and polycarbonates such as polypropylene carbonate (PPC) or a co-polymer. J. Mol. Model. 23, article: 6, (2017), which is hereby incorporated by reference, describes a plurality of SEI-forming electrolyte additives for lithium-ion batteries. In general, the formed SEI composition, for Li batteries, comprises one or more of: LiF, Li alkyl carbonate, Li₂CO₃, Li₂O, Li alkoxides, and the like. These compositions can be formed reduction of electrolyte, solvent, and/or salt at the anode during battery formation. H. Wu et al (Recent Progress in Understanding Solid Electrolyte Interphase on Lithium Metal Anodes, in Advanced Energy Materials vol 11, issue 5, 2021, 2003092), which is hereby incorporated by referenced, provides an overview of materials, additives, and SEI-formation on lithium metal anodes. Inventors find that for the anode metals other than Li (e.g. K and/or Na) similar principles hold in terms of additives, SEI formation and protective properties thereof.

The second layer may contain similar or even the same metal salts but typically within a different polymer matrix. This matrix can advantageously be specifically tuned for resisting permeation of solvents comprised in the plating electrolyte 302. In a preferred embodiment, the matrix polymer of the second layer comprises one or more of a polyfluorinated polymer, such as polyvinylidene fluoride (PVDF), PVDF-HFP, and polyacrylonitrile (PAN) or copolymers thereof. Alternatively, or in addition, the matrix polymer of the second layer may comprise one or more of polyamide, polypropylene and polyethylene.

To further improve metal ion conductivity the solid or semi-solid electrolyte 20, preferably at least the second layer, may contain and/or one or more inorganic filler particles including one of more of filler particles of a first type comprising, or essentially consisting of, an inorganic dielectric composition, and/or one or a more filler particles of a second type comprising, or essentially consisting of, solid-state electrolyte particles such as LLZO, Li metal halide, LATP.

The dielectric can be metal oxide or metalloid-oxide based, e.g. SiO₂, TiO₂, or combinations thereof. Preferably, the particles comprise, or essentially consist of a high-k dielectric, i.e. a material having a dielectric constant well in excess of about 4, at least over a temperature range of about 20° C. to about 100° C. Preferably, the dielectric constant is ≥20, more preferably ≥40. Most preferably the dielectric constant is in excess of 100. Suitable materials include but are not limited to metal titanates (MTIOx), including but not limited to barium-, strontium-, calcium-, copper-, and yttrium-based titanates as well as combinations and/or derivatives thereof, e.g. doped metal titanates. Preferred examples include barium titanate, strontium titanate, and combinations thereof. In addition to improving ion conductivity, incorporation of dielectric particles was found to advantageously improve homogenization of an electric field across the hybrid solid electrolyte layer. Inventors believe incorporation of dielectric fillers can homogenize metal ion transport across the layers and/or mitigate dendrite formation at an interface with an anode material as a result of repetitive charging and discharging cycles. Inventors found that the higher the dielectric constant the better the homogenization can be. Preferably the particles are predominantly discrete particles with a homogeneous distribution within the hybrid solid electrolyte layer and/or in a sub-layer thereof. In addition to aligning the field the dielectric particles are found to advantageously reduce the softening and/or glass transition temperature of the polymer matrix, thus contributing to ion conductivity of the hybrid solid electrolyte.

The electrolyte 20 will generally have a thickness in a range of about 10 to 50 micrometer. Thicker layers improve the protection of the underplated anode metal from ambient and from contact with plating liquids. The electrolyte 20 may be thicker, e.g. up to 100 μm or more but inventors find that benefits as to anode metal layer may no longer increase proportionally. The first layer (SEI-forming layer 21) generally has a thickness in excess of 500 nm, preferably ≥1 μm or ≥2 μm, e.g. in a range of about 1-10 μm. Thinner layers may reduce effectiveness of the formed SEI layer in protecting the anode metal from degradation by reaction with ambient. The second layer (solvent resistive layer 22) typically has a thickness t22≥5 μm, preferably ≥10 μm, e.g. in a range of about 10-40 μm.

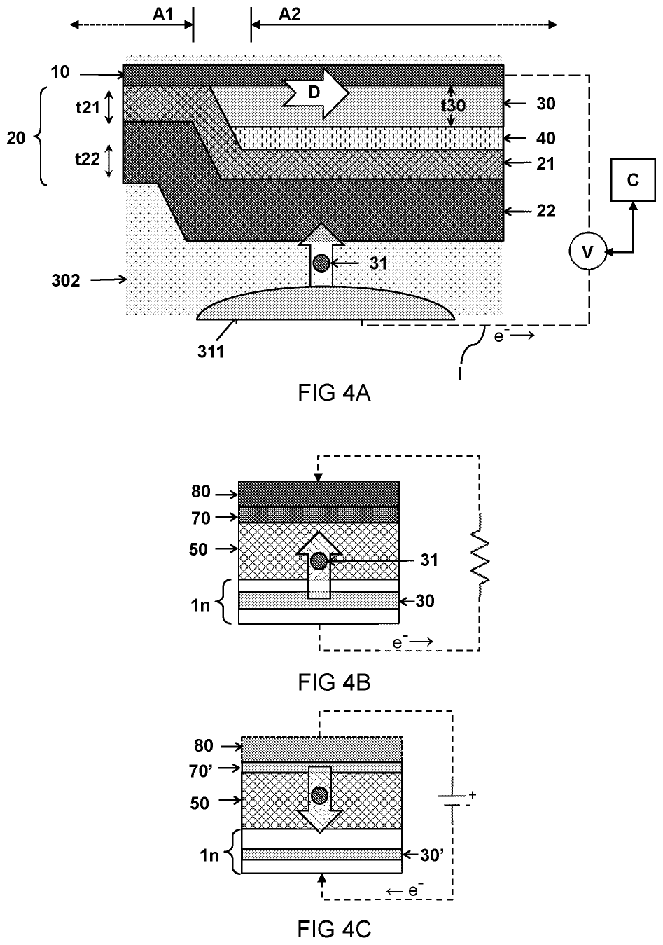

The thickness of the formed anode metal layer can advantageously be tuned to a desired specification, e.g. by controlling one or more plating conditions, as will be explained in more detail with reference to FIGS. 2B and 4A. In general, thickness t30 of the deposited anode metal layer 30 depends on an intended application of the electrode part 1n. For some battery applications the thickness of the anode metal layer, e.g. a lithium metal layer may be tuned within a range of 1-5 μm.

In some embodiments the current collector element 10, e.g. as shown in FIG. 1A may be a metal element, e.g. a planar element such as a foil, formed of any metal composition that is stable during battery operation (not partaking in redox reactions). Typically the metal may comprise, or even essentially consist of, copper of nickel. In other or further embodiments, e.g. as shown in FIG. 1B, the current collector element 10 may be provided as an electron conductive film 11, e.g. a copper film, provided along a face of a carrier 12, e.g. a polymer or metal foil.

In a preferred embodiment, e.g. as shown in FIGS. 2A, 2B, and 3A the current collector element 10 is formed as a flexible foil, e.g. as a metal film or as a conductive film 11 on a flexible carrier 12. Typically the foil has a thickness in a range of 1-50 μm. Preferably, the foil has a thickness in a range of 5-15 μm which offers a good balance in flexibility and handling properties.

Accordingly, the method 100 can advantageously be configured as a roll-to-roll process. Advantageously the current collector element can have an industrially relevant width, e.g. up to 3 m, e.g. in a range of 0.3-2.5 m, allowing large-scale production of pre-loaded electrode parts.

FIG. 2A schematically illustrates a method 100 of manufacturing an electrode part as disclosed herein that is configured as a continuous roll-to-roll process. In the method current collector element 10, supplied from a roll (left) is conveyed to a station for plating 300 an amount of an anode metal composition 30 as a layer between the current collector element 10 and the electrolyte 20 covering the current collector element 10 by electroplating.

Prior to plating the method comprises a step of coating 200 the current collector 10 with a layer of the composite solid or semi-solid state electrolyte 20. Although not shown in full detail the solid-state electrolyte 20 is formed as a stack of two distinct layers including i) the first layer 21 covering the current collector element 10 that, at least initially contains, the one or more functional additives forming a solid electrolyte interphase (SEI) and ii) the second layer 22 that covers the first layer 30 and that is resistive to inward permeation of solvent comprised in the plating electrolyte. Each of the layers comprised in the electrolyte 20 can be provided using known methods in the field including slot die coating, extrusion, spin coating, dip coating, etc.

After plating 300 the amount of an anode metal composition 30, the formed pre-loaded electrode part 1n is collected on a roller (far right in FIG. 2A) for storage. Optionally the formed electrode part may be cut to pieces for storage and/or processed directly, e.g. for manufacturing a battery.

It will be appreciated that, as an alternative, the method can be configured as a sheet-by-sheet process.

FIGS. 2B, 3A and 4A illustrate the electroplating 300, wherein FIG. 4A provides a more detailed view of a region marked in FIG. 2B.

In general terms the plating process produces a metal coating, an anode metal coating 30, on the current collector element 10 through the reduction of cations of that metal by means of a direct electric current. The current collector element 10 acts as the cathode (negative electrode) of an electrolytic cell; the plating electrolyte is a solution comprising a salt of the metal to be coated (e.g. a Li-salt). The anode (positive electrode) is typically formed by an electrode comprising the corresponding metal usually either a block of that metal, or of some inert conductive material. The current is provided by an external power supply.

In an embodiment, as shown in FIGS. 2B and 3A, the current collector element 10 with the coating of an electrolyte 20 (shown as a single layer in FIG. 2B for clarity), is conveyed through an electrochemical plating bath 301. As the plating results in the formation of a protective SEI layer the plating in particular and the production process as a whole can be conveniently performed in a dry-room environment, without a need for reducing or eliminating O₂, N₂ and/or CO₂ levels in the ambient atmosphere.

The bath 301 contains a liquid plating electrolyte 302 into which the film is immersed. For Li-metal plating the electrolyte will comprise a lithium salt, such as one or more of LiTSI, LIFSI, LiNO₃, LiF, LiCIO₄, LIF, LIBF₄, LiBOB, LiDFOB, and LiPF₆; and a solvent. The solvent is typically selected from one or more of: Ionic liquids, Carbonates, Ethers, Fluorinated ethers, Fluorinated carbonates, Organophosphates, Solvents with Sulphonyl groups, Ester solvents. For example, one or more of: DOL (Dioxolane), DME (Dimethoxyethane), EC (Ethylene carbonate), and DEC (Diethyl carbonate), DMC (dimethylcarbonate), FEC (Fluoroethylene carbonate), VC (Vinylene carbonate), PC (Propylene carbonate), HFE (Hydrofluoroethers), FEMC (trifluoroethyl methyl carbonate). It will be appreciated that selection of solvent and constituents of the electrolyte 20, in particular the second layer 22 will be mutually selected so to avoid solvent from penetrating through the solid or semi-solid state electrolyte 20. Temperature of the bath during plating depends on the type of metal to be plated. For lithium plating temperature is generally controlled to a temperature within a range of 20-80° C.

The plating electrolyte 302 is in contact with a source 310 of anode metal ions (e.g. Li ions). Optionally, the source may be anode metal ions as provided by the amount of anode metal salt in the electrolyte itself. In which case the anode metal salt will need to be replenished periodically or continuously during plating to prevent anode metal ion depletion. Preferably, the source is provided by a solid source, e.g. a metal or metal oxide. This source can be connected as the cathode (negative electrode) of an electrolytic cell continuously replenishing anode metal ions lost by plating onto the current collector element 10 (connected as anode of the cell).

For lithium plating the source can be a Li metal source. Advantageously the source may contain oxides, hydroxides or carbonates, as commonly present on the surface of commercially obtained lithium metal (e.g. foil).

As detailed in FIG. 4A anode metal ions 31 transfer through the solid electrolyte 20 layer for plating as anode metal 40 layer onto the anode metal composition 30 between. By reaction of plated anode metal (e.g. Li⁰) with SEI-additives comprised in the first layer 21 an SEI layer 40 is formed. because the SEI layer allows transport of anode metal ions further and anode metal can be plated through the SEI layer. Note that foil is conveyed (marked direction D, in FIG. 4A) regions A1, initially without anode metal layer, become regions A2 comprising a pre-loaded amount of anode metal.

The SEI layer is formed at the interface between plated anode metal and the electrolyte 20. Formation of the SEI layer terminates either by a self-limiting character of the SEI-forming process, or by consumption of the SEI-forming additives.

The SEI layer forms an intrinsic protection of the underlying anode metal, mitigation its degradation of Li metal losses due to a reaction with ambient. The electrolyte 20, in particular the second layer, protects the formed anode metal from reaction with solvents comprised in the plating electrolyte 302. Because both protective layers are present as of plating the anode metal, the formed anode metal layer can be exceptionally pure, free of degradation products, as compared to electrode parts manufactured whereby the electrolyte and/or SEI layer is only deposited or generated after completing deposition of the anode metal.

Thickness of electrolyte 20 is preferably in a range of 10-50 μm. The first layer 21, comprising the SEI-forming additives preferably has a thickness t21, at least initially, in a range of 1-10 μm. The second layer, resistive to permeation of solvent comprised in the plating electrolyte 302 typically has a thickness in a range of 10-40 μm. The formed SEI layer can advantageously be a conformal cover layer having a thickness in excess of about 1 μm. More preferably thicker, e.g. ≥2 μm, such as in a range of 1-5 μm, a range of 2-5 μm, a range of 1-10 μm or a range of 2-10 μm.

The anode metal (e.g. Li) plating is based on known principles. Plating can be performed by direct current mode; pulse mode, or reverse pulse mode. The amount of plated anode metal layer can be conveniently controlled by controlling one or more plating conditions.

In a preferred embodiment, the method comprises controlling, preferably by a controller C, the amount of the electroplated anode metal layer 30, e.g. a thickness (t30) by adjusting one or more of adjusting a magnitude, a duration and/or a pulse shape of an electroplating current I during the electroplating and/or by controlling a contact time of the substrate with the plating electrolyte. Accordingly, the electrode part (1n) can be provided with a specific amount of anode metal, e.g. a pre-defined target.

For rechargeable anode metal-ion batteries, e.g. as shown in FIG. 1A, the thickness of the anode metal amount is preferably ≥1 μm, more preferably ≥2 μm, e.g. 5-10 μm. Optionally up to 50 or even 100 μm. The thicker the anode metal layer the larger the buffer capacity of the battery and the longer operational lifetime may be. Thinner layers are possible but offer less buffer capacity and/or may become discontinuous offering reduced performance as to homogenization of plated anode metal during a battery charging operation.

For secondary Li—S or Li-air batteries, e.g. as shown in FIGS. 4B and 4C, the anode metal layer defines the lithium inventory of the battery. Accordingly, the amount per unit area of pre-loaded anode metal is typically larger, e.g. ≥50 μm, preferably ≥100 μm, e.g. between 1 and 200 μm, or larger.

Preferably, the source is in the form of a roller, e.g. as shown in FIGS. 2B, 3A, and 3B. For example, a roller comprising a main body 313, covered with a film or layer (e.g. foil) as anode metal source 311. Preferably, roller and/or conveying system is configured to adjust a position of relative separation distance between the source and the current collector element 10. E.g. by mounting the roller on an adjustable holder 314, as shown.

In a preferred embodiment, the roller and/or system the source and/or roller are adjustable so that, during operation the source can be in a direct contact with an external face 20f of the electrolyte 20. Adjusting a separation distance between the source and the electrolyte 20, up to a direct contact, advantageously reduces an ion-diffusion pathlength between source the current collector element 10. The adjustable roller can further advantageously maintain a separation distance between the roller and the electrolyte coating 20, e.g. a direct contact, even as anode metal on the roller is consumed.

In some embodiments, e.g. as shown in FIG. 2B, the roller is patterned to include portions without anode metal source. Patterning the source, e.g. by including gaps 311g without anode metal source around a perimeter of the roller, can advantageously yield electrode parts 1n wherein the plated anode method layer comprises regions with reduced thickness or even gaps without plated anode metal.

In some embodiments the substrate foil is guided between a pair of rollers 310,320 configured to apply a compression pressure onto the formed layer of the anode metal composition 30, during plating. Preferably between the anode metal roll and an opposingly positioned adjustable counter roller 320.

Applying a contact pressure to the foil as the layer on anode metal is deposited can advantageously reduce a porosity of deposited anode metal, e.g. Li⁰. Additionally, such configuration can be used to facilitate the E-field applied at the point of plating. Additionally, applying a contact pressure to the foil as the layer on anode metal is deposited can advantageously reduce an overall volume of plating electrolyte 302.

In some embodiments, e.g. as shown in FIG. 2B (depicting a roller separated at a distance from the foil) an elastomeric layer 312 is provided around the body 313 of at least one of the rollers 310. The elastomeric layer can advantageously homogenize the applied contact force by mitigating spike forces, e.g. due to surface roughness.

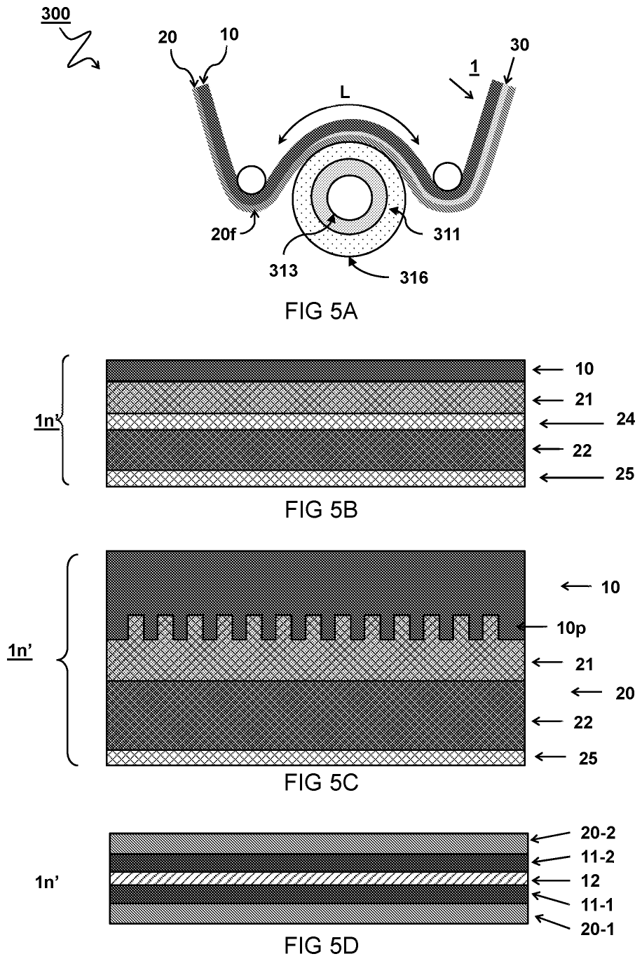

In other or further preferred embodiments the foil is wrapped around a part of a perimeter of the plating roller, e.g. as shown in FIG. 5A. Wrapping the foil around a portion of the roller forms an overlap with increased contact area with the roller as compared to a comparatively narrow or line contact as shown in FIG. 3A. Wrapping the foil around the part of the roller can advantageously increase a contact time (plating time) between foil and roller for a given conveying speed. Increasing a contact time can advantageously reduce areal plating rates. The length of the overlap L can be varied, e.g. by positioning a displaceable roller. In some embodiments the overlap can be ≥10% of the roller external surface area or more, e.g. ≥20% or ≥30%, up to about 50% or even more, e.g. up to about 75% by using one or more additional guidance rollers.

In a preferred embodiment, the plating rate is set to ≤5 μm/h. Lower plating rates were found to provide more consistent, more uniform, plating. Best lithium anode metal quality was found for plating rates≤1 μm/h.

In yet other or further preferred embodiments, a porous separator 315 is provided between the roller 310 and the substrate e.g. the foil, during plating. The separator can advantageously reduce an overall volume of plating electrolyte 302 in the bath or even essentially contain the overall amount of the plating electrolyte 302. In some embodiments, the porous separator is provided as a temporary layer onto the solid or semi-solid electrolyte 20. Alternatively, or in addition, the separator can be supplied as a separate sheet between the foil and the roller, e.g. to be conveyed along with the foil by a roller, preferably the anode metal roller. FIG. 3A illustrates a plating process, wherein separator 315 is conveyed along with the foil 10,20 by the anode metal roller 310. In a preferred embodiment, e.g. as shown, the separator 315 is conveyed as an invite loop, preferably with the aid of one or more adjustable tension rollers 318. Note that in the embodiment as shown anode metal roller 310 and counter roller 320 have been adjusted so contact the foil. A controller C is provided to maintain a contact pressure. Note that the position of the rollers 310,320 may be adjusted to maintain contact with the foil as anode metal 311 is consumed over time.

Yet further alternatively or in addition, e.g. as shown in FIG. 3B, the separator can be configured as a layer 315 along an external face of the roller 310.

Providing the porous separator with working electrolyte along a face of the roller or as a separately conveyed sheet 315 mitigates a need to remove a separator from the product following processing. Preferably, the separator is a compressible separator (elastic). Providing a compressible (elastic) separator advantageously improves a contact to the electrolyte 20 and allows reducing/cushioning peak forces, e.g. due to undulations on the roller and/or product.

It will be understood that for plating of one or more other or further anode metals (e.g. Na or K) the plating source, plating electrolyte, and conditions will be adjusted appropriately.

In some embodiment the plating can be an essentially dry plating process. A dry plating process can be realized by employing a dry or semi dry plating electrolyte layer or belt between the foil and the anode metal source. Dry or semi dry plating process reduced or eliminate adverse reaction between solvent and plated anode metal. In some variations, the dry or semi-dry electrolyte can be a solid or semi-solid electrolyte layer 316 provided around the plating roller, e.g. as illustrated in FIG. 5A. In other embodiments the dry or semi-dry electrolyte may be provided as a sheet or belt between roller and foil. I will be appreciated that small amounts of a liquid electrolyte can be provided as wetting agent to improve contact with the foil. In case of using a dry or semi dry plating process the second electrolyte layer can be understood as providing structural integrity to the stack. In particular the second layer 22 (compare FIG. 4A) can be understood as being formed of a comparatively harder composition (e.g. a comparatively harder polymer or even ceramic layer as disclosed herein) than the first layer. This allows the first layer to be comparatively soft, or even a gel, which is beneficial to mitigate damages due contact forces during dry or semi-dry plating. A gelatinous first layer is particularly envisioned in combination with conforming to a 3D structured current collector, e.g. as discussed with reference to FIGS. 2C-D and 5C.

Additional and as an alternative to plating from an external source the electrode part as disclosed herein can also be used to advantage in battery products without providing the electrode with a pre-loaded amount of anode metal (e.g. lithium). In such applications the plating electrolyte and anode metal source can be provided in situ within the battery, e.g. a cathode composition and solid state electrolyte, from which anode metal is plated, e.g. upon an initial battery charging routine.

In some preferred embodiments, e.g. as shown in FIG. 5B one or more inorganic layers 25 are provided on top of the second layer 22 of the electrolyte coating 20. Alternatively, or in addition, one or more further inorganic layers can be provided between the first 21 and the second layer 22 of the electrolyte coating 20. The one or more inorganic layer(s) 24,25 can further reduce cross talk between the first layer and the plating environment. The inorganic layer can, but need not be, of the same or similar composition. In either case the ceramic layer will be transgressive to anode metals salts (alkali or earth alkaline ions, e.g. lithium ions). Anode metal ion, e.g., Li-ion. conductivity can be realized by compositions that are suitably thin (e.g. ≤5 nm) or compositions that are intrinsically anode-metal-ion conductive, such as LiPON.

FIGS. 5B, 5C and 5D illustrate exemplary electrode parts 1n′ prior to preloading an anode metal composition. Prior to preloading by the electroplating means that the electrode part can be understood as being essentially free of anode metal. As such these parts can be understood as starting products for the plating process described herein. In line with the disclosure as a whole these parts comprise at least a current collector element 10 and an electrolyte coating 20. The electrode part comprises no pre-deposited amount of anode metal. The electrolyte coating contains i) a first layer 21 covering the current collector element 10 that contains one or more functional additives forming a solid electrolyte interphase 40 layer upon reaction with a plated anode metal composition 30 provided by the electroplating, and ii) a second layer 22 covering the first layer as disclosed herein. The second layer can be understood as being more resistive than the first layer to plating solvent, in particular to ingress of solvents used in subsequent electroplating.

In some embodiments, a thin ceramic layer 24 is provided between the first 21 and the second 22 layer of the electrolyte coating to further mitigate solvent ingress and/or solvent exchange into/from the second layer while allowing Li-ion transduction. In other or further embodiments, a thin layer of ceramic 24 to mitigate solvent ingress and/or exchange while allowing Li-ion transduction. In yet further embodiments, e.g. as shown, the second layer 22 is sandwiched between the first and second ceramic layer. In addition to mitigating solvent ingress/exchange the ceramic layer(s) can increase a rigidity of the electrolyte coating 20. This can be particularly beneficial in case the current collector element 10 is 3D structured current collector comprising a plurality of outwardly extending elongate protrusions 10p in combination with a gelly or semi-solid first layer.

In other or further variations there is provided a doubly sided coated anode. FIG. 5D illustrates an anode part 1n′ (prior to electro plating) having a doubly coated current collector element comprising a carrier foil 12 11 that is coated on opposing sides with respective ones of an electron conductive metal film 11-1, 11-2, each of which are provided with a respective one of the electrolyte coating 20-1,20-2 as disclosed herein.

These dual sided electrodes can be used to advantage in the assembly of a battery cell stack. Depending on the nature of subsequent cover layers provided on either face, e.g. cathodic or anodic, these dual electrodes can be used for assembly of a serial or bipolar cell stack. In some preferred embodiments, e.g. as shown in FIG. 1B, the electrode part 1n comprises a nucleation layer 15. The nucleation or alloying layer being applied to the current collector element 10, e.g. directly onto the metal coating 11 as shown, can advantageously improve the homogeneity of anode metal cover layers formed thereon during subsequent electroplating. The nucleation layer is believed to act as a wetting layer between the current collector element 10 and the anode metal composition 30. For lithium based batteries the seed layer can be referred to as lithiophilic. For other metals the layer may e.g. be referred to as sodiophilic or potassiophillic. The seed layer generally comprises, or essentially consists of, electron conductive compositions including but not limited to one or more of Zn, Sn, In, Mg, Al, Ti, Mo, Cr, carbon graphitic, graphene-like, etc. The wetting effect is believed to be, at least in part, based on the seed layer composition alloying with the anode metal composition. When such an alloying layer is comparatively thin (e.g. 10 nm-500 nm), it may be regarded as a seeding layer. When the layer is thicker (up to e.g. 20 μm), it may be viewed as a host material for the anode metal. Accordingly, the subsequently provided anode metal layer may be regarded as an alloy of one or more anode metal(s) and the seed composition (e.g. Sn—Li, In—Li, Zn—Li, etc. in case Lithium is used as the anode metal). In either case, the seeding/alloying layer enables homogenous anode metal deposition on the current collector element, improving battery performance and reliability. Optionally, the seed composition may include oxides, e.g. hydroxides, thereof, e.g. ZnOₓ. These oxides will be reduced by contact with the comparatively more electropositive anode metal composition.

The seed layer 15 is generally provided directly prior to depositing the electrolyte 20. Suitable methods include ALD, PVD, CVD, and electroplating. For structured current collector elements 10, e.g. as discussed in relation to FIGS. 2C and 2D, conformal layer deposition methods such as ALD and/or electroplating may be preferred. Optionally, the nucleation layer may be plated through electrolyte layer 20 or another solid electrolyte layer.

It will be appreciated that the present disclosures further relate to electrode parts, preferably obtainable by the methods as disclosed herein. In particular to an electrode part comprising a current collector element with a solid or semi-solid electrolyte layer provided thereon, and a pre-loaded amount of an anode metal composition provided as a layer between the current collector element and the electrolyte.

Additionally, the disclosure relates to energy storage devices, e.g. batteries, comprising the electrode part (1n), and to methods of manufacturing such devices.

Turning to FIG. 1A there is depicted a pre-loaded electrode part 1n that comprises an anode metal composition 30 provided as a layer between a current collector element 10 and a solid electrolyte layer 20. As shown in more detail in FIG. 1B a solid electrolyte interphase (SEI) layer 40 is formed along an interface between the electrolyte and the layer of the anode metal composition 30.

In a preferred embodiment, e.g. as shown the electrolyte 20 that comprises i) a first layer 21 covering the current collector element 10, and ii) a second layer 22 covering the first layer. The SEI layers as obtained by the disclosed methods can advantageously have a thickness (t30, see FIG. 4A) in a range allowing the electrode to be manufactured in dry room environments. As detailed with reference to the method the first layer, at least prior to plating contains, one or more functional additives for forming a solid electrolyte interphase 40 layer by reaction with the plated anode metal composition 30. The second layer is resistive to inward permeation of solvent comprised in the plating electrolyte 302 towards the plated anode metal composition 30.

The electrode can be characterized by a mitigated degradation and/or homogeneity of the pre-loaded amount of the anode metal due to the protective SEI layer formed directly along with deposition of the anode metal. In contrast, electrodes comprising a pre-loaded anode metal layer that is deposited prior to forming an SEI layer will have comparatively larger Li-losses and/or corresponding inhomogeneities due to reacted product with ambient, e.g. air.

In some embodiments, e.g. as shown in FIG. 1B, the electrode part In comprises a seed layer 15.

Advantageously, the pre-loaded electrode part 1n can be flexible, e.g. foil, as explained in relation to FIGS. 2A and 2B.

In some embodiments, the current collector element is a 3D structured element comprising a plurality of outwardly extending elongate protrusions. FIG. 2C illustrates an exemplary current collector element 10 comprising protrusions 11p that extend outwardly from a conductive base 11b. The base can be a metal foil or film. Alternatively or in addition, the base can be provided on a carrier, e.g. flexible carrier 12. The base with the protrusions, e.g. in the form of pillars or columns, forms a scaffold structure onto which the solid or semi-solid electrolyte 20 cover is deposited. Accordingly, the structure serves to carry the amount of anode metal composition as deposited by plating.

Preferably, the protrusions are electrically conductive at least along an exterior face (e.g. sidewalls) so as to improve current transport to/from the base. Formed pre-loaded 3D electrodes advantageously offer improved performance in terms of capacity and rate.

It will be appreciated that when the electrolyte 20 is provided as a multiplayer stack that the first layer 21, comprising the SEI-additives, will preferably extend into the 3D current collector, whereas the second layer 22, the solvent-resistive layer, will preferably be provided as a planar cover layer (not extending between the pillars), e.g. as illustrated in FIG. 2D.

Optionally, the electrolyte may be formed as a single layer that is resistive to inward permeation of solvent comprised in the plating electrolyte and that comprises the SEI-forming additives.

Exemplary embodiments relating to the energy storage devices comprising the electrode part 1n as disclosed herein, as well as method of manufacturing such devices will now be described with reference to FIGS. 1A, 3B and 3C.

FIG. 3C schematically illustrates a method 500 of manufacturing a battery 1000. The method comprises: providing 501 the electrode part 1n as disclosed herein having a pre-loaded amount of anode metal; and assembling 510 the part in a battery structure opposite a counter electrode part 1p. As described in relation to FIG. 1A the method may further comprise one or more of: providing one or more further separator 50 structure between the electrode part 1n and the counter electrode part 1p. Alternatively, or in addition, the method may include providing, one or more electrolyte compositions, such as a catholyte 60, to improve ion transport between cathode and anode.

FIGS. 1A, 4B and 4C illustrate exemplary embodiments of a battery 1000 comprising the electrode part 1n as disclosed herein and a counter electrode part 1p.

In some preferred embodiments, e.g. as shown in FIGS. 1A and 2B the battery includes a cathode composition 70 that is provided along a face of the counter electrode part 1p.

In a particularly preferred embodiment the battery is formed as a secondary lithium metal ion battery, wherein both the cathode composition 70 and the pre-loaded layer of the anode metal composition 30 comprise lithium. Note that the pre-loaded lithium metal layer can advantageously provide a buffer amount of lithium additional to a lithium inventory provided by the cathode composition. The pre-loaded lithium metal layer acts as nucleation, or plating, layer for subsequently in-situ plated lithium metal (e.g. during an initial or subsequent charging operations) and as a buffer to replace losses from the lithium inventory composition during at least initial ones of lithium metal plating and de-plating processes during battery operation. The make-up of the cathode composition as well as methods of providing the cathode composition 70 are well-known in the field. Suitable compositions include lithium-metal salts, e.g. LiM-oxide compositions or lithium metal sulfide (LiM-S) compositions. For example, Li-loaded ceramics, such as LiₓM_{y}O_{z} or LiₐM_{b}PO₄ (wherein M is typically one or more of Co, Ni, Al, Mn, Fe, and Sn).

In other embodiments the accessible anode metal inventory is predominantly, or even exclusively, determined by the amount of pre-loaded anode metal preloaded with a lithium metal layer 30.

FIG. 4B illustrates a secondary lithium battery, formed as a secondary lithium-sulfur (Li—S) battery. The electrode part 1n is separated by an additional separator 50 from a counter electrode comprising a positive current collector structure 80 with a sulfur cathode (S₈) cathode composition. The additional separator 50 is optional in view of the electrolyte coating 20 provided on the current collector element 10. However additional separator 50 may be applied to improve ion transport between anode and cathode. The battery is depicted during a discharge cycle wherein electrons from a lithium oxidation reaction at the anode travel via an external load to the cathode. The lithium ions in the electrolyte migrate to the cathode where the sulfur is reduced to lithium sulfide (Li₂S). During a recharge cycle the sulfur is re-oxidized and lithium ions travel back to reduce at the anode.

FIG. 4C illustrates a secondary lithium battery, formed as a secondary lithium-air (Li—S) battery that uses oxidation of lithium at the anode and reduction of oxygen at the cathode to induce a flow of electrons e, marked as current T′. Similar to the Li—S battery the anode metal (lithium) inventory within the battery is predominantly, or even exclusively, determined by the amount of pre-loaded anode metal (lithium) which is cycled between the anode and cathode during respective charge and discharge operations.

The battery is depicted (with an optional additional separator 50) during a charge cycle at a partially charged state, whereby part of the lithium inventory is in a reduced (metal state) at the anode 30′ and the remainder part is contained in oxidized form 70′ at the cathode.

For the purpose of clarity and a concise description, features are described herein as part of the same or separate embodiments, however, it will be appreciated that the scope of the invention may include embodiments having combinations of all or some of the features described. Of course, it is to be appreciated that any one of the above embodiments or processes may be combined with one or more other embodiments or processes to provide even further improvements in finding and matching designs and advantages.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. A method of manufacturing an electrode part comprising a current collector element and an electrolyte coating, the method comprising:
depositing an amount of an anode metal composition as a layer between the current collector element and the electrolyte covering the current collector element by an electroplating process that involves a directed transfer of anode metal ions through the electrolyte coating from a plating electrolyte to the current collector element, wherein
the electrolyte coating comprises i) a first layer covering the current collector element that, at least initially contains, one or more functional additives forming a solid electrolyte interphase layer by reaction with the plated anode metal composition, and ii) a second layer covering the first layer that is more resistive than the first layer to inward permeation of solvent comprised in the plating electrolyte towards the plated anode metal composition.

2. The method according to claim 1, comprising the steps of
depositing a first electrolyte composition or precursor thereto onto the current collector element to form the first layer, and
depositing a second electrolyte composition or precursor thereto onto the deposited first layer to form the second layer.

3. The method according to claim 1, wherein the current collector element is formed as a flexible foil, and wherein the method is configured as a roll-to-roll process comprising conveying the foil past a station configured for loading of conveyed sections of foil by the electroplating process.

4. The method according to claim 1, wherein the anode metal source is an anode metal roll.

5. The method according to claim 1, comprising controlling, preferably by a controller (C), the amount of the electroplated anode metal layer in accordance with a predefined target by one or more of adjusting a magnitude, a duration and/or a pulse shape of an electroplating current during the electroplating and/or by controlling a contact time of the substrate with the plating electrolyte.

6. The method according to claim 1, comprising, prior to depositing the anode metal composition and prior to providing the electrolyte coating, a step of coating the current collector element with one or more layer of a composition alloying with the anode metal composition.

7. The method according to claim 1, wherein, during the electroplating, the substrate is guided between a pair of rollers, configured to apply a compression pressure onto the formed layer of the anode metal composition.

8. The method according to claim 4, wherein, during the plating, a porous separator is provided between the anode metal roll and the electrolyte.

9. The method according to claim 1, comprising providing an ion diffusive layer onto the electrolyte along an external face opposite the current collector element, said ion diffusive layer comprising a composition configured for further resisting ingress of solvent comprised in the plating electrolyte towards the electrolyte.

10. An electrode part, preferably obtainable by the method according to claim 1, comprising
a current collector element with an electrolyte coating provided thereon, the electrolyte coating containing i) a first layer covering the current collector element that optionally contains one or more functional additives forming a solid electrolyte interphase layer upon reaction with a plated anode metal composition provided by the electroplating, and ii) a second layer covering the first layer that is more plating-solvent resistive than the first layer,
a pre-loaded amount of an anode metal composition provided as a layer between the current collector element and the electrolyte coating, and
a solid electrolyte interphase formed as a layer along an interface between the coat of the electrolyte and the layer of the anode metal composition.

11. The electrode part according to claim 10, wherein the current collector element is a flexible foil.

12. The electrode part according to claim 10, wherein the current collector element comprises a plurality of elongate protrusions extending outwardly from a conductive base.

13. An electrode part for use in the electroplating process according to claim 1, the part comprising
a current collector element, and
an electrolyte coating provided thereon,
wherein the electrode part comprises no pre-deposited amount of anode metal, and wherein the electrolyte coating contains i) a first layer covering the current collector element that contains one or more functional additives forming a solid electrolyte interphase layer upon reaction with a plated anode metal composition provided by the electroplating, and ii) a second layer covering the first layer that is more plating-solvent resistive than the first layer.

14. The electrode part according to claim 10, wherein the electrode part is a dual sided electrode part having respective ones of the electrolyte coating provided on opposing sides of the current collector element.

15. A method of manufacturing a battery, comprising
manufacturing the electrode part according to any of claim 1, and
assembling the obtained part opposite a counter electrode part.

16. A battery comprising the electrode part according to claim 10, and a counter electrode part positioned across the electrode part.

17. The battery according to claim 16 formed as a secondary lithium metal ion battery wherein the pre-loaded layer of the anode metal composition comprises lithium, the battery further including a lithium ion comprising cathode composition whereby the pre-loaded lithium metal layer provides a buffer amount of lithium additional to a lithium inventory provided by the cathode composition.

18. The battery according to claim 16 formed as a secondary lithium-sulfur battery or a secondary lithium-air battery, wherein the layer of the anode metal composition comprises lithium that provides an overall lithium inventory of the battery.

19. The method according to claim 4, wherein the anode metal roll is a lithium metal roll.

20. The method according to claim 7, wherein the pair of metal rollers is the anode metal roll and an opposingly positioned counter roller.
